(19) United States
(12) Patent Application Publication
(10) Pub. No.: US 2010/0236367 A1
(43) Pub. Date: Sep. 23, 2010

(54) SACHET OPENER

(76) Inventor: Leopoldo Goncalves Pinto De Aquino Almeida, Rio De Janeiro (BR)

Correspondence Address: WRB-IP LLP, 801 N. Pitt Sreet , Suite 123, ALEXANDRIA, VA, 22314, US

(21) Appl. No.: 12/670,569

(22) PCT Filed: Aug. 12, 2008
(86) PCT No.: PCT/BR08/00238

§ 371 Date: Jun. 2, 2010

(30) Foreign Application Priority Data
Aug. 13, 2007 (BR) MU8701635-4
Mar. 13, 2008 (BR) MU8800326-4

(51) Int. Cl. B26D 1/02; B67B 7/46; B26D 1/03

(52) U.S. Cl. 83/440; 83/856; 83/444

(57) ABSTRACT

An opener for sachets containing, e.g., ketchup, mustard, mayonnaise, etc., is provided. The opener includes a main body including a flat plate with at least one groove, through which the sachet is passed, and a cutting blade at the end of the groove, which cutting blade cuts the sachet. The opener is fastened somewhere in, for instance, a restaurant and a sachet can be opened by using only one hand.

### BACKGROUND AND SUMMARY

The present invention relates to a device for opening sachets with primarily edible contents, using only one hand, such as ketchup, mustard, mayonnaise, vinegar, oil and others that may be packed in little sachets. The present invention makes it possible to open these small containers rapidly and comfortably and in a hygienic and practical way. A problem with these sachets is the difficulty to open them. Many consumers have to plan their meals by opening several sachets before the meal. If they open the sachets during the meal, the opening of the sachet becomes inconvenient. The person who opens a sachet whilst eating either have to interrupt their meal for a while, or they try to open it with their teeth, or they simply abstain from the desired seasoning.

According to a survey via the internet, there are some planned law reforms that will force restaurants and fast food establishments to utilize only sachets for different seasoning additives such as ketchup and mustard. In the same survey, it was noted that one of the reasons for intoxication has been seasonings offered in different types of bottles. The reason for this is of course that these seasonings have a certain validity time which occasionally may be exceeded. With the help of small sachets, this problem is solved.

The small individual sachets fulfil their hygienic purposes and their producers have tried to facilitate their opening as far as possible. For this purpose, they provide grooves or perforations to simplify for the consumer to tear the sachet at the right place. However, in spite of these provisions, we can observe that it is very common that a consumer puts the sachet in the mouth and opens it with his/her teeth. When doing this, the consumer becomes exposed to another type of contamination, different from the mentioned intoxication: he/she is exposed to virus and bacteria present on the outside of the packing. A further inconvenience is of course that, when opening the sachet with the teeth or with both hands, the consumer may spill on his clothes and other objects nearby.

The sachet opener according to an aspect of the present invention comprises a device that can be incorporated into or fixed on any place functioning together with other utilities that are common for bars/restaurants, such as napkin holders, straw holders, the sachet holder itself, etc., onwards simply called “restaurant utilities”. The sachet opener may be fixed onto a restaurant utility and the opener comprises a part with a groove and a cutting edge accessibly provided on one side, where the user can pass a sachet into the groove and cut off a part of the sachet with the cutting edge at the end of the groove. Other sachet openers are known, see for instance the Brazilian document MU8600542-1. However, the present invention is different, according to an aspect thereof, in that it is divided in two parts, one being fastenable onto the restaurant utility and the other removable and replaceable. One of the parts is the cutter as such and the other is the frame or holder, that is fastened on the restaurant utility, which frame or holder is construed to accommodate the cutting blade in its body, or even making part of the restaurant utility. These two parts are separated to co-exist with the restaurant utility, the holder being attached to the restaurant utility and the blade to be fastened onto the holder.

This interaction between the opener according to an aspect of the invention and the restaurant utility makes it a unique and different product in comparison with the state of the art and it may be applied onto any surface in any position, making possible either a cutting movement upwards or downwards, thereby permitting the opening of sachets containing an easily spilled liquid, such as vinegar, olive oil and soy. Further, the opener according to an aspect of the invention does not occupy more place on the table or the bar, thereby leaving more space free. Moreover, the cutting blade is replaceable when it becomes too blunt, thereby diminishing the amount of polymer/plastic waste of the holder, which can be maintained. Finally, the opener has a very low production cost, it can be used by a very large amount of people and it is hygienic and safe for the users.

### BRIEF DESCRIPTION OF THE DRAWINGS

For illustrative but not limiting purposes, the invention will now be described with reference to the attached drawings, which are:

FIG. 1 shows a top view of the opener according to the invention.

FIG. 2 shows the cross-section of the opener of FIG. 1, along the groove 3 in FIG. 1.

FIG. 3 shows another embodiment of the invention.

FIG. 4 shows another embodiment of the cutting blade according to the invention.

FIG. 5 illustrates a cutting sequence according to the present invention.

FIG. 6 shows a frame that is going to hold the holder with its cutting blade.

FIG. 7 shows how the frame may be attached to a restaurant utility.

FIG. 8 shows an example of a frame fastened to a restaurant utility.

FIG. 9 shows the assembly according to the invention fixed to a restaurant utility.

FIG. 10 shows the two parts of the opener assembled.

FIG. 11 shows the opening process when there is an obstacle.

FIG. 12 shows the opening process according to the invention.

FIG. 13 shows how the opener may be attached in any position.

FIG. 14 shows another embodiment according to the invention.

FIG. 15 shows a further embodiment of the invention.

FIG. 16 shows a further embodiment of the invention.

FIG. 17 shows a further embodiment of the invention.

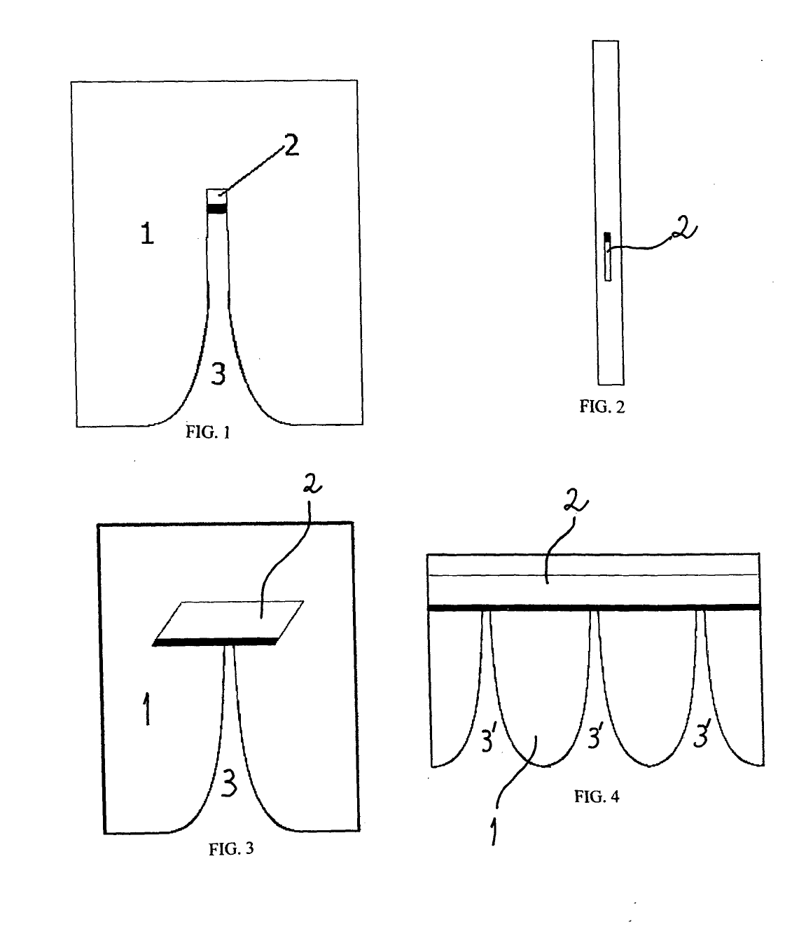

### DETAILED DESCRIPTION

Referring to the figures, the user will pass a corner part of a sachet through the groove 3 of the opener according to the invention. In this movement, the sachet will pass over the cutting blade 2, which will cut off a corner part of the sachet and, thereby, open the sachet. According to the figures, the opener comprises two parts. One of the parts is a flat piece 1 with a groove 3, which extends from one edge of the piece to the blade 2. Actually, the groove may extend beyond the blade 2, but in that case, for practical purposes, the blade defines the end of the groove. The groove 3 guides the sachet during a continuous movement of the same, from one end of the groove towards the other end of the groove, within the groove, thereby cutting the sachet with the cutting blade 2. The cutter blade is normally of metal but can also be of a hard polymer. The flat piece 1 is normally made of a plastic (polymer) material, but could also be made of stiff paper. Among suitable polymers can be mentioned acrylic plastic, polyethylene and polypropylene. It can be made of two layers, with the blade fastened between these two. However, in accordance with FIG. 3, it can also be made of one sole layer, with the cutting blade 2 fixed on one side thereof, for instance by gluing. In principle, the blade can be fastened in any suitable way, for instance, by gluing, screws, pins, protrusions (cf. FIG. 17). It can even be made in one sole piece with the plate 1, if the plastic material allows for a sufficiently sharp edge.

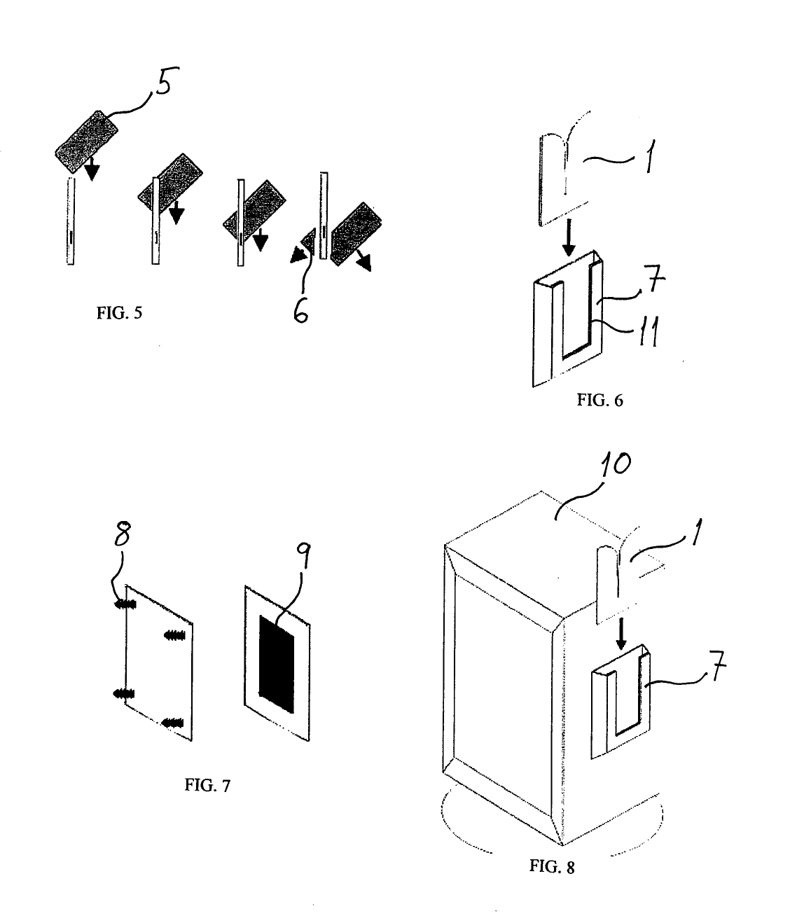

In agreement with FIG. 4, the flat piece 1 can also comprise several grooves 3′, thereby increasing the capacity of the cutting blade.

FIG. 5 shows a cutting sequence of the sachet opener of the invention. It is rather self-explanatory. The sachet 5 is pushed through the groove of the opener and a corner 6 of the sachet is cut off. Obviously, this can be done by using only one hand, since the opener is fixed at, e.g., a restaurant utility.

FIGS. 6 and 10 show how the opener 1 can be held in a frame 7. The three edges 11 of the frame 7 can be provided with a groove to hold the opener 1 firmly. When the blade 2 is worn out, the opener 1 is replaced by a new equal one. This frame 7 can be fastened practically anywhere in a restaurant, bar, fast food place, etc. The frame can be fastened, e.g., by screws 8 or a piece of tape 9 that is adhesive on both sides, as illustrated in FIG. 7.

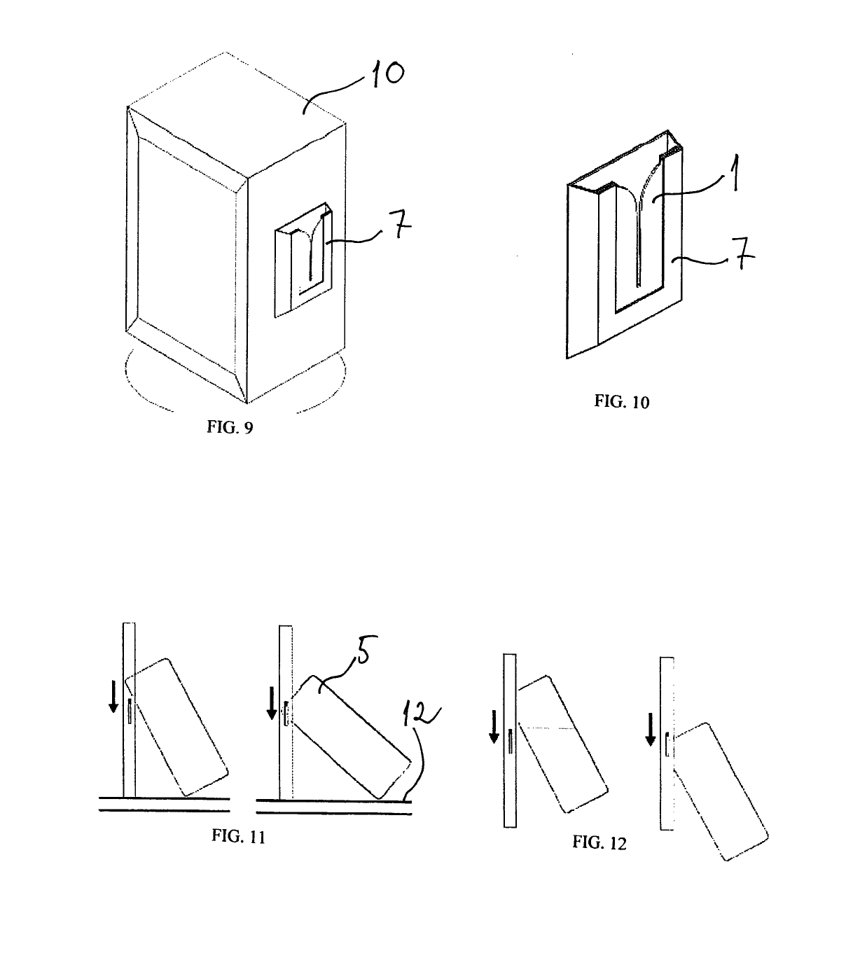

FIGS. 8 and 9 show the frame 7 fastened on a napkin holder 10.

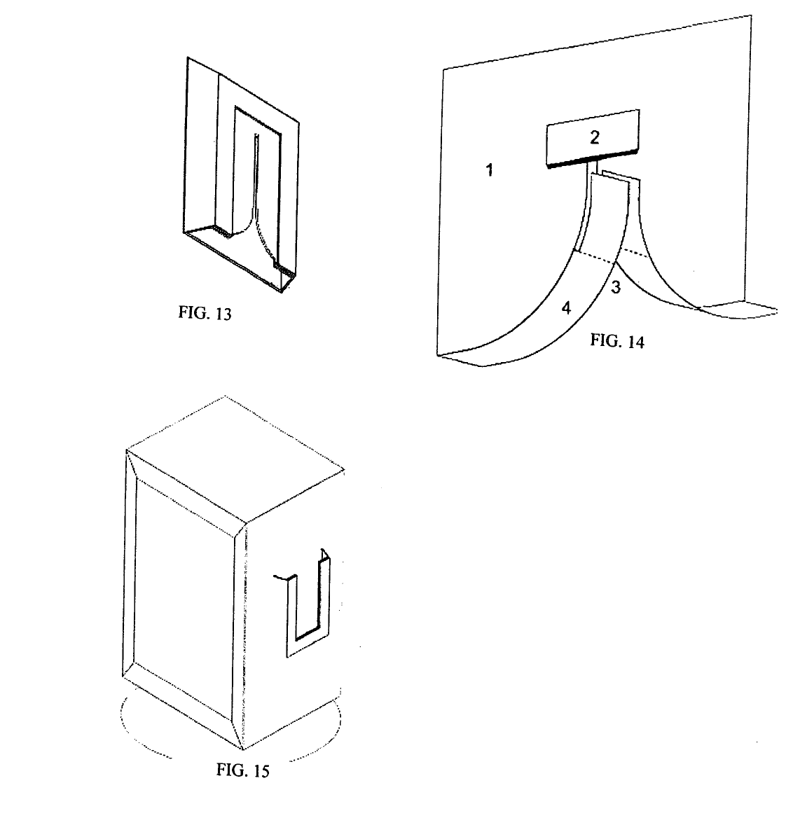

FIG. 11 illustrates how the cutting movement can be impeded by an obstructing surface 12 if the opener would, e.g., be placed too near a table or a bar surface. FIG. 12 shows how this obstruction is avoided by placing the opener at a sufficient distance from any obstacle.

FIG. 13 shows how the opener and the frame can be placed upside down, if for instance the content of the sachet is very liquid and easily spilt.

FIG. 14 shows another preferred embodiment. According to this embodiment, when the user passes the sachet through the groove 3, his/her applied force will make the two pressing members 5 exert a pressure on the sachet, thereby squeezing the contents inside the sachet away from the cut and avoiding spilling. The pressing members 5 can be integral and in one piece with the main plate 1, but they can also be separate and fastened on the plate 1. Further, they can be of another material than the plate 1.

FIG. 15 shows how the frame 7 can be integrated with a restaurant utility, so that the utility is manufactured with the frame from the very beginning.

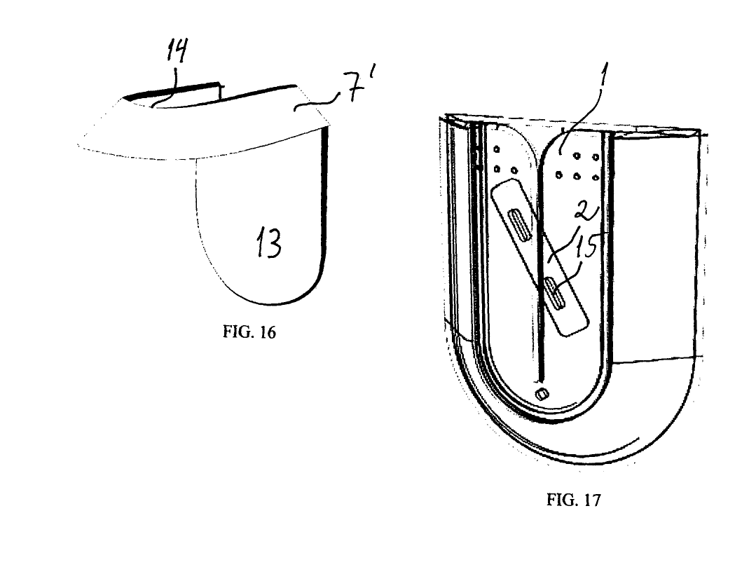

The frame 7 can also be made in such a way that the frame part 1′ can be pivoted upwards from the base 13, thereby facilitating the cleaning within the frame. Further, the plate 1 of the opener can have a rounded lower edge, with a corresponding rounded frame part 14 in the frame, as illustrated in FIG. 16 and also in FIG. 17. FIG. 17 shows an opener with an inclined cutting blade 2, to further improve the cutting action. The plate 1 is shown transparent to make it possible to see the blade 2. The plate 1 consists of or comprises two layers with protrusions and matching orifices, to clamp and hold the two parts together. The blade 2 has holes 15, through which protrusions from one plate layer stick. The figures show a square, rectangular or a rounded edge form of the plate 1. However, it could have any other shape as well, e.g., trapezoidal, triangular or an isoscelous triangle.

The invention has been described in connection with seasoning food stuffs. However, it could equally well be used for other products, for instance, a detergent, a shampoo, a lubricant, etc.

1. Sachet opener comprising a main body composed of a flat plate with at least one groove, through which a sachet is passed, and a cutting blade at the end of the groove, which cutting blade cuts the sachet.

2. Opener according to claim 1, wherein the opener is square or rectangular or has two parallel sides and a rounded end edge.

3. Opener according to claim 2, wherein the cutting blade is of plastic or metal.

4. Opener according to claim 2, wherein the opener is made of a polymer material, metal, stiff paper or wood.

5. Opener according to claim 2, it wherein the opener comprises between 1 and 10 grooves, each groove ending with a cutting edge.

6. Opener according to claim 2, wherein pressing members are provided along the edges of the groove, in order to squeeze the contents of the sachet away from the cut.

7. Assembly for opening sachets, comprising an opener according to claim 1 and a holder or frame for holding the opener.

8. Assembly according to claim 7, wherein the frame or holder is fastened on a restaurant utility.

9. Opener according to claim 1, wherein the cutting blade is of plastic or metal.

10. Opener according to claim 1, wherein the opener is made of a polymer material, metal, stiff paper or wood.

11. Opener according to claim 1, wherein the opener comprises between 1 and 10 grooves, each groove ending with a cutting edge.

12. Opener according to claim 1, wherein pressing members are provided along the edges of the groove, in order to squeeze the contents of the sachet away from the cut.

13. Opener according to claim 3, wherein the opener is made of a polymer material, metal, stiff paper or wood.

14. Opener according to claim 3, wherein the opener comprises between 1 and 10 grooves, each groove ending with a cutting edge.

15. Opener according to claim 3, wherein pressing members are provided along the edges of the groove, in order to squeeze the contents of the sachet away from the cut.
